(19) United States
(12) Patent Application Publication
(10) Pub. No.: US 2022/0205284 A1
(43) Pub. Date: Jun. 30, 2022

(54) DEVICE COMPATIBLE ENCLOSURE APPARATUS

(71) Applicants: Steven Wai-Tong Cheung, Plainview, NY (US); Sergio Portella Dealbuquerque, Plainview, NY (US)

(72) Inventors: Steven Wai-Tong Cheung, Plainview, NY (US); Sergio Portella Dealbuquerque, Plainview, NY (US)

(21) Appl. No.: 17/562,935

(22) Filed: Dec. 27, 2021

Related U.S. Application Data
(60) Provisional application No. 63/131,290, filed on Dec. 28, 2020.

(51) Int. Cl. E05B 73/00; A45C 11/00

(52) U.S. Cl. CPC E05B 73/0082; A45C 11/00; A45C 2011/002; A45C 2011/003; E05B 73/0005

(57) ABSTRACT

An apparatus for securely enclosing a portable electronic or computing device using device compatible mounts and/or a device locking mechanism is described. The apparatus may comprise a front retaining frame and a device compatible back plate. The portable electronic or computing device may be enclosed between the front frame and the back plate in some implementations. The back plate may include VESA compatible mounting patterns in some implementations. In some implementations, the front frame and the black plate prevent unauthorized access to one or more controls of the enclosed device while leaving the screen of the enclosed device visible and while permitting audio to pass freely from the enclosed device to the ambient environment as well as from the ambient environment to the enclosed device.

### RELATED APPLICATIONS

This application claims the benefit of U.S. Provisional Application No. 63/131,290, titled “VESA Mount Standard Compatible and Kensington-Lock Ready Enclosure with Optional IP Rating and Inductive Charging for Portable Electronic Devices”, and filed on Dec. 28, 2020, which is incorporated herein by reference in its entirety.

### Definitions

The term “VESA” herein/hereafter refers to the “VESA Mounting Interface Standard”, colloquially referred to as “VESA Mount”, which is a family of standards defined by the Video Electronics Standards Association (or VESA) for mounting flat panel monitors, televisions (“TV”), and other displays on stands or onto walls. It is implemented on devices including but not limited to, flat panel monitors or screens, TVs, and electronic or computing tablets designed for mounting.

The term “Kensington Slot” refers to a Kensington Security Slot, which is a part of an anti-theft system designed and patented by Kryptonite in 1999-2000 under U.S. Pat. Nos. 6,081,974, 6,317,936, and 6,360,405; into which slot a Kensington Lock can be inserted, other locking slots, apertures or devices can be used.

### BACKGROUND

Traditionally, in setups where a programmable touch interface that is amenable to human interaction is required, a monitor with touch overlay that is connected to a computer is typically used. These specialized setups have various applications, such as, but not limited to, point-of-sale (POS) kiosks, interactive displays for information, human-to-machine interface (HMI) for factories, and digital signage. Furthermore, these devices usually feature VESA ready mounting slots/holes to allow custom-built or purpose-built devices to be securely and permanently fixed.

As portable electronic and computing devices, e.g., tablets, have increasingly become affordable, efforts have been made to replace personal computer and touch screen setups with tablets to lower the installation and operating costs. This is typically implemented by building enclosures to house the devices and integrating the enclosures into existing or new VESA-ready setups through the use of VESA-ready mounting holes/slots in the existing or new installations.

However, such VESA-ready enclosures present challenges. One such challenge is the ability to power the enclosed devices using low voltage wiring including but not limited to CATS networking cables, which can carry both power and data, and the ability to conceal such wiring and cables. For example, these setups/installations typically require an adapter or a dongle that can transform a single low voltage line into a line that can carry both power and data to the setup.

Designs in the prior art, such as those in U.S. Publication No. 2013/0109253A1, U.S. Pat. No. 8,542,495B1, and U.S. Design No. D6764485 do not address the above challenges completely. For example, provisions for VESA mounts or cabling are lacking in such designs.

In the design shown in U.S. Publication No. 2014/0109253A1, the apparatus requires a specialized proprietary connector for each unique electronic device involved. The design also requires the connector to be positioned in a very specific location within the apparatus. Further, as new tablet models are released, there may arise a need to design and manufacture new tools and connectors to interface with the apparatus disclosed in the above publication. The tooling and engineering of specialized connectors further adds to the cost of production of connectors.

Similarly, in U.S. Pat. No. 8,542,495B1 and U.S. Design No. D676448A, the disclosed apparatus resolves the above problem of requiring specialized connectors by simply providing a much wider bezel that surrounds the periphery of the enclosed device. With this change, void space is always available for cables to be connected to/within the edges of the device where the respective input/output (I/O) ports are located. Manufacturers employing this strategy typically create a limited number of enclosure sizes, e.g., “small,” “medium,” and “large”, to install “7-inch to 8-inch” devices, “9-inch to 10-inch” devices, or “11-inch and up” devices respectively.

While each of these designs can physically accommodate devices of different sizes, the different size of devices necessitates the addition of differently sized internally installed corner brackets to center align such differently sized devices. This requirement, while simplifying the stocking requirement of different connectors and reducing the tooling cost of connectors, may force a tradeoff by increasing the complexity and the stocking requirements of the manufacturer and others in the supply chain owing to the increased number of SKUs. This may also increase the complexity of installation for customers as different devices of different sizes will require different, precisely sized corner brackets. Furthermore, since each of the aforementioned enclosures are fixed in size and shape, the aesthetic appeal of the setup/installation may suffer due to the oversized, wider-than-necessary bezel for accommodating multiple devices. This leads to adverse consequences, e.g., the inability to use such enclosures in certain point-of-sale (POS) scenarios where a compact design and a small footprint are critical, and in high-end setups, where the unnecessarily large bezel makes the design look bulky and visually unappealing.

Another challenge in installing/setting up interactive display solutions for use in tethered, semi-portable, and/or outdoor environments involves exposure to the elements including but not limited to dust and water, which can damage and shorten the life of the devices enclosed therein. Scenarios where limited device portability and ingress protection of the setup is required may include but are not limited to retail usage, pop-up stores, or restaurants with outside dining.

Designs in the prior art, such as those in CA Patent No. 2,862,097, which shows an “Explosion Proof Tablet Enclosure”, and U.S. Pat. No. 7,907,394 B2, which shows a “Protective Enclosure for Touch Screen Device”, appear to provide portability and resistance against dust and water ingression. However, these designs make no mention of the mounting compatibility of such enclosures, for example, at fixed locations, or whether they require any VESA-ready brackets or mounts, nor do the above referenced designs show any options for tethering the enclosures in order to make them a secure yet portable solution within a fixed radius. Similarly, while the designs shown in U.S. Publication No. 2013/0109253A1 and U.S. Design No. D676,4485 are VESA mount-ready, these designs do not make any mention of weatherproofing or protection against the elements, e.g., dust and/or water ingression, thereby making such designs unsuitable for use outdoors or where limited portability is required.

Yet another challenge is the requirement of support for wireless charging of portable electronic devices—wireless charging eliminates the need for routing of wires and cables to supply power to devices. Wireless charging through inductive charging generally requires the charging coil to be in close proximity to the device being charged. The designs shown in the prior art place an enclosure around the tablet, thereby constraining or restricting the tablet's wireless charging and forcing the use of a wire or a cable for power, data, or other electronic communication. Use of wires/cables/connectors makes ingress protection difficult to implement.

As of the filing of this application, there appear to be only custom-made designs to address the disclosed requirements, with no “in stock” or “off the shelf” commercially available products. Thus, setups/installations based on the above prior art designs may need a user to make compromises, including, leaving the wiring exposed, using unsightly or bulky bezels to fill void space, leaving empty slots for auxiliary power supply cables, and/or lack of ingress protection. Additional complications may arise if the setup/installation is in a public or a semi-public space, for example, due to partially exposed wiring, exposure to elements, or lack of standards-based secure mounting. The above compromises/limitations/complications may increase the cost of ownership as the setup/installation may also be vulnerable to vandalism or unwanted damage.

Designs in the prior art may therefore result in setups/installations that are not properly secured or that are not protected from the elements. Such designs may also suffer from a higher cost of installation due to the need for specialized parts that are not commonly available or may not be aesthetically pleasing to the eye or otherwise not meet the aesthetical requirements of users. Therefore, there may exist a need for a solution that addresses the issues discussed herein.

### SUMMARY

Some implementations include an apparatus for enclosing an electronic device. In some implementations, the apparatus comprises a front frame for retaining the electronic device, wherein a bezel of the front frame includes one or more slots, and wherein the one or more slots align with one or more of one or more input ports or one or more output ports of the electronic device. In some implementations, the apparatus also comprises a back plate for enclosing the electronic device, wherein the back plate includes one or more device compatible mounting patterns for mounting the electronic device. In some implementations, the one or more slots are covered with an acoustically transparent material. In some implementations, the acoustically transparent material is waterproof.

In some implementations, the apparatus includes one or more device mounting holes. In some implementations, the one or more device mounting holes include one or more of one or more through holes and/or one or more blind holes. In some implementations, the one or more blind holes are covered with one or more of silicone, plastic, sealant, or foam.

In some implementations, the back plate comprises a through hole, wherein the through hole forms a passageway for one or more of cables, wires, or connectors. In some implementations, the back plate comprises one or more waterproof cable glands to enable the passage of one or more of cables, wires, or connectors.

In some implementations, the back plate comprises one or more channels. In some implementations, the one or more channels originate at one or more of the one or more input ports or the one or more output ports of the electronic device. In some implementations, the one or more channels terminate at one or more of a through hole of the back plate or one or more cable glands of the back plate. In some implementations, the back plate comprises one or more pre-milled knockout sections. In some implementations, one or more of the one or more pre-milled knockout sections comprise one or more service holes.

In some implementations, the apparatus further comprises a gasket for hermetically sealing the apparatus when the electronic device is enclosed between the front frame and the back plate, wherein the gasket is one or more of dust-proof or waterproof. In some implementations, the back plate comprises one or more bumpers, wherein the one or more bumpers are made of one or more of an elastomeric, a rubber-like, or a spring-like material.

In some implementations, the apparatus further comprises a locking device mounting point.

In some implementations, the front frame is affixed to the back plate using one or more of fasteners, a slide and snap fit mechanism, an adhesive, a security screw head mechanism, or ultrasonic welding.

Some implementations include an apparatus for enclosing an electronic device. In some implementations, the apparatus comprises a front frame for retaining the electronic device. In some implementations, the apparatus also comprises a back plate for enclosing the electronic device. In some implementations, the apparatus further comprises a locking device mounting point, wherein the locking device mounting point is one or more of affixed, embedded, fastened, or attached to one or more of the front frame or the back plate.

In some implementations, the apparatus comprises one or more fixed contact points, wherein the one or more fixed contact points include one or more of one or more pogo pins or one or more spring-loaded pins.

Some implementations include a method for securing an electronic device. In some implementations, the method comprises enclosing the electronic device between a front frame and a back plate, wherein the back plate further comprises a locking device mounting point, and wherein the back plate includes one or more device compatible mounting patterns for mounting the electronic device. In some implementations, the method also comprises mounting a Kensington Lock on the locking device mounting point of the back plate.

### BRIEF DESCRIPTION OF THE DRAWINGS

FIG. 1 is a perspective view of an example device mount compatible enclosure in accordance with some implementations.

FIG. 2 is a rear view of an example front frame of an example device mount compatible enclosure in accordance with some implementations.

FIG. 3 is a rear view of an example front frame of an example device mount compatible enclosure in accordance with some implementations.

FIG. 4 is a rear cutaway view of an example front frame of an example device mount compatible enclosure in accordance with some implementations.

FIG. 5 is a rear view of an example front frame of an example device mount compatible enclosure along with a separate view of a specialized device connector in accordance with some implementations.

FIG. 6 is a front isometric view of an example front frame of an example device mount compatible enclosure with an example device not completely fitted in the front frame in accordance with some implementations.

FIG. 7 is a front isometric view of an example front frame of an example device mount compatible enclosure with an example device completely fitted in the front frame in accordance with some implementations.

FIG. 8 is a rear isometric view of an example front frame of an example device mount compatible enclosure with an example device not completely fitted in the front frame in accordance with some implementations.

FIG. 9 is a rear isometric view of an example front frame of an example device mount compatible enclosure with an example device completely fitted in accordance with some implementations.

FIG. 10 is a front isometric view of an example front frame of an example device mount compatible enclosure with an example device not completely fitted in accordance with some implementations.

FIG. 11 is a front isometric view of an example front frame of an example device mount compatible enclosure with an example device completely fitted in accordance with some implementations.

FIG. 12 is a rear isometric view of an example front frame of an example device mount compatible enclosure with an example device not completely fitted in accordance with some implementations.

FIG. 13 is a rear isometric view of an example device mount compatible enclosure with an example device and an example gasket in accordance with some implementations.

FIG. 14 is a rear isometric view of an example device mount compatible enclosure in accordance with some implementations.

FIG. 15 is a front isometric view of an example device mount compatible enclosure in accordance with some implementations.

FIG. 16 is a front cutaway view of an example back plate of an example VESA mount standard compliant enclosure along with a magnified view of an example fastener used in the enclosure in accordance with some implementations.

FIG. 17 is a cutaway view of an example VESA mounting pattern of an example VESA mount standard compliant enclosure in accordance with some implementations.

FIG. 18 is a cutaway view of an example VESA mounting pattern of an example VESA mount standard compliant enclosure in accordance with some implementations.

FIG. 19 is a front perspective view of an example back plate of an example device mount compatible enclosure in accordance with some implementations.

FIG. 20 is a front perspective view of an example back plate of an example device mount compatible enclosure in accordance with some implementations.

FIG. 21 is a rear isometric view of an example back plate of an example device mount compatible enclosure in accordance with some implementations.

FIG. 22 is a rear view of an example back plate of an example device mount compatible enclosure in accordance with some implementations.

FIG. 23 is a rear cutaway view of an example back plate of an example device mount compatible enclosure in accordance with some implementations.

FIG. 24 is a rear cutaway view of an example front frame of an example device mount compatible enclosure in accordance with some implementations.

FIG. 25 is a rear cutaway view of an example back plate of an example device mount compatible enclosure in accordance with some implementations.

FIG. 26 shows rear cutaway views of an example back plate of an example device mount compatible enclosure in accordance with some implementations.

FIG. 27 shows isometric rear views of a front frame and a back plate of an example device mount compatible enclosure in accordance with some implementations.

FIG. 28 is a rear cutaway view of an example back plate of an example device mount compatible enclosure in accordance with some implementations.

FIG. 29 is a rear cutaway view of an example back plate of an example device mount compatible enclosure in accordance with some implementations.

FIG. 30 is a rear isometric view of an example device mount compatible enclosure along with a magnified view of an example fastener used in the enclosure in accordance with some implementations.

FIG. 31 is a rear isometric view of an example device mount compatible enclosure along with a magnified view of an example fastener used in the enclosure in accordance with some implementations.

FIG. 32 shows front and top views of a Kensington Lock assembly for use with an example device mount compatible enclosure in accordance with some implementations.

FIG. 33 is a rear view of an example back plate of an example device mount compatible enclosure in accordance with some implementations.

### DETAILED DESCRIPTION

Those of ordinary skill in the art will realize that the following detailed description of the present disclosure is illustrative only and is not intended to be in any way limiting. Other embodiments of the present disclosure will readily suggest themselves to such skilled persons having the benefit of this disclosure. Reference will now be made in detail to implementations of the present disclosure as illustrated in the accompanying drawings. The same reference indicators will be used throughout the drawings and the following detailed description to refer to the same or like parts.

This disclosure pertains to an apparatus that enables a portable or a compact computer or tablet or computing or electronic device (“device”) to be installed at either a fixed or a portable location and that appropriately secures the device against unauthorized removal. The apparatus pertaining to the disclosure may be designed using two or more pieces that can be combined into a single unit. These pieces comprise at least a front retaining frame (“front frame”) and a back plate, which sandwich and enclose and protect the device. The disclosed apparatus can be designed and manufactured in different sizes to accommodate devices of different sizes. Based on the level of ingress protection needed, additional components and/or features can also be included to protect the device from the elements, e.g., water and/or dust.

Some implementations include a front frame that is attached to a device. A bezel of the front frame (“bezel”) in some implementations is designed to include or comprise a number of slots/holes at locations that match, include, or encompass the various input/output ports located on the device, including but not limited to a 3.5 mm headphone port, an Apple® Lightning port, a micro-USB/USB-A/USB-C port(s), an HDMI port, a display port, a Thunderbolt port, or other such ports. In some implementations, the sizes and shapes of these input/output slots/ports align with and are compatible with original equipment manufacturer (OEM) cables/wires and/or accessories supplied with the device and do not require any additional and/or proprietary cables, wires, add-ons, connectors, and/or interconnectors to interface with the device. This reduces the cost of installation of the device within the apparatus disclosed herein (“apparatus”). In some implementations, the bezel may be designed with the smallest thickness possible. in some implementations, the bezel may use custom/specialized cable(s)/connector(s) to enable or accommodate various features, e.g., power charging of and/or data-transfer to/from the device. In some implementations, the front frame may include slots or holes to accommodate any protrusions emanating or arising from or attached to or included in the device, including but not limited to a power button and one or more volume buttons. in some implementations, the front frame may feature a bezel whose front retaining hole (“front hole”) may be designed to accommodate a specific model of a device while allowing unfettered access to the front surface or screen of the device. In some other implementations, the front hole may be designed to not only accommodate a specific model of a device but may also be designed such that the bezel accommodates one or more of the front-facing elements of the device, including but not limited to a front-facing camera, a light sensor, a LIDAR sensor, a home button, back button(s), menu button(s), and/or sections of the device's screen/display, depending on customer specifications. In some implementations, when the bezel is designed to accommodate front-facing elements, an additional hole/slot or a series of holes/slots may be located at one or more location(s) to allow access to different features or controls of the device, including but not limited to a front-facing button, a front-facing camera, a home button, back button(s), a light sensor, or a LIDAR sensor.

In some implementations, the Apparatus includes grooves along the internal periphery of the underside of the Bezel and these grooves lead to the device's microphone and/or speaker ports. This arrangement renders a “hole-free” or “slot-free” design when viewed from any angle, while providing open-air sound pathways for proper acoustic performance without sacrificing the aesthetics of the apparatus. In some implementations, the grooves over the device's audio input or output, e.g., microphone and/or speakers, are designed to be acoustically transparent and are made using waterproof material, including but not limited to expanded polytetrafluoroethylene (ePTFE) fabric. The placement and location of this fabric may vary and can be made at any location along the groove to maximize audio performance and/or minimize production costs. Moreover, audio pathways covered by such fabric are protected from the elements, including, e.g., dust and/or water, and improve the device's potential ingress protection (“IP”) rating. In some implementations, for additional ingress protection, the Bezel may be designed to include a gasket such that when the apparatus is assembled, dust and/or water is prevented from entering the apparatus. The gasket can be made of one or more pieces in some implementations to seal both the Front Hole and the periphery of the apparatus where two or more parts come together to form an enclosure. In some implementations, only the front interactive touch screen may be exposed, where the screen is a single pane of glass that is water and dust proof by default.

In some implementations, to accommodate devices with built-in microphone(s) and/or speaker(s), the apparatus may include additional slot(s) that are designed to allow sound waves to be received into microphone(s) or other input ports/slots and/or to disperse sound waves from speaker(s) or other output ports/slots. In some implementations, an enclosure of the apparatus or a periphery of the enclosure of the apparatus may be designed to include such additional slot(s).

In some implementations, the front frame may include one or more ridges, flanges, protrusions, dips, and/or depressions on its perimeter or on its periphery to interface or interlock with a corresponding profile of a device so as to accommodate the device in the apparatus.

In some implementations, the apparatus includes a VESA-standard compliant back plate that has mounting patterns which are compatible with common VESA sizes, including but not limited to 75×75 mm and 100×100 mm. In some implementations, VESA mounting holes on the apparatus may include a threaded PEM nut embedded in a through hole or a blind hole to enable a machine screw to secure the apparatus onto any VESA compatible mounting apparatus. In some implementations, when the threaded PEM nut is embedded in a through hole, additional dustproof and/or waterproof material, including but not limited to silicone, plastic, sealants, or foam can be added to the through hole on the side facing the enclosed device to guard against ingress of dust and/or water and improve the device's potential ingress protection (IP) rating.

In some implementations, the back plate may include a through hole located near the center of the back plate (“thru hole”) to allow cables, wires, connectors, or other elements to pass through the back plate. In some implementations, the back plate may include waterproof cable gland(s) (“gland(s)”) located near the center of the back plate or at location(s) near the device's input/output port(s) (“I/O Port(s)”), to allow cabling to pass through while ensuring that the enclosed device is waterproofed. Multiple glands may be used in some implementations.

In some implementations, the back plate may also include one or more radial clearance channels (“channels”) that originate near the device's I/O Ports and terminate at the thru hole or the glands and act as pathways for cables or wires to run along the back plate or the device.

In some implementations, pre-milled grooves (“PMG”) may be designed using a thin material to form a knockout section that is then included in the back plate. The PMG can be removed or penetrated using a cutting tool in some implementations. When the thin material is removed and the PMG area is exposed, cable(s) and/or wire(s) and/or connector(s) from the inside of the apparatus can exit the back plate at a location of the installer's choosing. This feature allows the apparatus to be used with a variety of VESA-standard compliant mounting brackets as not all models may feature a center through hole or an exit hole. In such cases, without PMGs, cables, wires, and/or connectors would not be able to exit through such holes.

In some implementations, for devices with built-in microphone(s) and/or speaker(s), the back plate may have an opening, including but not limited to a hole/slot, a series of holes/slots, a grille, and/or a combination of these to enable ambient sound waves to access the microphone and/or for the speaker to access ambient sound waves. In some implementations, the holes/slots enable audio to pass through. In some implementations, acoustically transparent and waterproof material, including but not limited to ePTFE fabric covers the holes/slots to provide protection to the holes/slots from the elements but allows audio to pass through the holes/slots. Thus, when the apparatus is assembled or installed, the covered holes/slots would not be an ingress method for dust and/or water, thereby improving the device's potential ingress protection (IP) rating also. In some implementations, the back plate is designed with one or more sections or surfaces shaped to enable sound waves to be focused into and received into microphone(s) or other input ports of the Device and/or to dispense sound waves from speaker(s) or other output ports of the device.

In some implementations, the back plate may include one or more profile elements, including but not limited to flanges, protrusions, dips, and/or depressions that match or align with and interlock with the front frame to secure their position relative to each other. In some implementations, the back plate may be manufactured with pre-milled knockouts for enabling access to device features, including but not limited to a power button, a fingerprint reader, volume button(s), and/or other actuators or controls. To access a device feature on the apparatus, the installer can remove the pre-milled knockouts and provide access to end user(s).

In some implementations, for example, where ingress protection or IP rating is not of importance, one or more service holes/slots may be included in the pre-milled knockouts of the back plate. This may be done, for example, to enable access to a button or an actuator inside the apparatus to tools, including but not limited to a paper clip, a needle, and/or a thin screwdriver, as the service hole/slot does not allow a finger to access button(s) or actuator(s) directly. In some implementations, the back plate may be designed with hole(s)/slot(s) and/or channels pre-milled at locations where the mounted device profile has features and/or protrusions exceeding the average thickness of the device profile. Such features and/or protrusions, for example, correspond to embedded cameras or LED lights for example. This arrangement enables the device to fit securely without the possibility of the features or the protrusion being damaged during the installation or use of the device. In some implementations, to ensure that the mounted device is positioned as flush as possible against the front hole, springs and/or supports made of spring-like materials, including but not limited to metal springs and/or plastic, elastomeric, or rubber bumpers may be added to the back plate to push the device in the apparatus forward.

In some implementations, the back plate may be designed with a through hole at locations where the mounted device has features or functionalities that require direct access to ambient environment. Examples of such features or functionalities include embedded cameras or LED lights. A through hole enables such features or functionalities to be operational while the device remains secured and protected. In some implementations, the back plate may be assembled together with the front frame using any number of manufacturing or installation methods, including but not limited to fasteners, slide and snap fit, adhesives, and/or ultrasonic welding. In some implementations, fasteners may be used to assemble or install the Apparatus. In some implementations, standard fasteners may be replaced with security screw head options, including but not limited to Torx and/or pin-in-hex to provide additional security to the device.

In some implementations, the Back Plate and/or the Front Frame may be designed to enable a custom water-tight gasket to be placed between the two pieces. When the pieces are assembled, the custom water-tight gasket deforms to match or align with the contour and the shape of the inside surface of the front frame's bezel and the back plate's perimeter, resulting in a water-tight and/or dust-resistant seal. The edges where the two pieces meet would therefore not become ingress pathways for dust and/or water, thereby improving the device's potential ingress protection (IP) rating. In some implementations, one or more edges and/or surfaces of the apparatus may include one or more protrusion(s), extension(s), and/or add-on(s) on the front frame and/or the back plate to accommodate a Kensington Security Slot to restrict the mobility of the apparatus, e.g., by securing the apparatus using a Kensington Lock and attached tether.

In some implementations, the front frame may be designed to enable a custom-fitted, optically clear and resistively and/or capacitively transparent material with a water-tight gasket to be placed between the inside of the front hole and the device's screen in the apparatus, thus providing a water-tight and/or a dust-resistant seal for the front face and the device's screen. This prevents edges where the front frame and the back plate meet from becoming ingress pathways for dust/water, thereby improving the device's potential ingress protection (IP) rating.

In some implementations, the back plate may be designed to include one or more pogo or spring-loaded pins or fixed contact points as interfaces for transferring power, data, or any other electronic or non-electronic signals from a VESA-standard compatible mounting bracket with matching pogo or spring-loaded pins or fixed contact points. In some implementations, some or all of the pogo or spring-loaded pins or fixed contact points may be integrated with a metal coil included in the back plate, resulting in the creation of a magnetic field when current is passed through and enabling wireless charging and/or data transmission to the device in the apparatus.

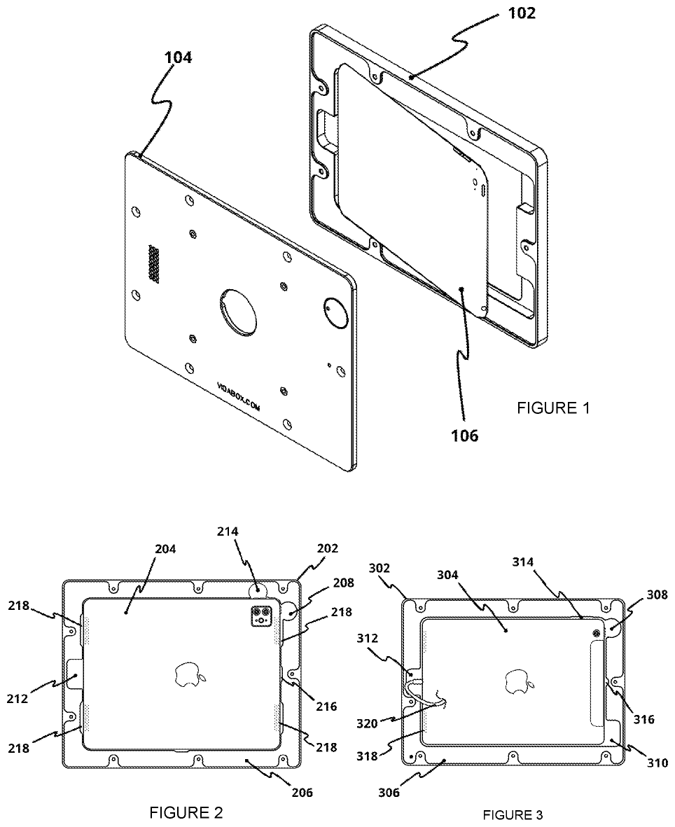

FIG. 1 is an isometric view of an example device mount compatible enclosure in accordance with some implementations. FIG. 1 shows the enclosure with a front frame (102) and a back plate (104), and an example device (106) enclosed between the frame and the plate.

FIG. 2 is a rear view of an example front frame of an example device mount compatible enclosure in accordance with some implementations. FIG. 2 shows a front frame (202) that encloses a first tablet (204), with the bezel (206) of the front frame (202) designed to include slot/hole cut-outs for the first tablet's power button (208), USB cable connector port (212), volume button(s) (214), microphone(s) (216), and speakers (218). The slot/hole cut-outs are precision cut and/or shaped to receive and focus sound waves into the microphone(s) (216) or disperse sound waves from the speaker(s) (218) to outside the enclosure.

FIG. 3 is a rear view of an example front frame of an example device mount compatible enclosure in accordance with some implementations. FIG. 3 shows a front frame (302) that encloses a second tablet (304), with the bezel (306) of the front frame (302) designed to include slot/hole cut-outs for the second tablet's power button (308), headphone port (310), USB cable connector port (312), volume button(s) (314), microphone(s) (316), speaker(s) (318), and an original equipment manufacturer (OEM) connector cable (320) that is inserted into a port (312).

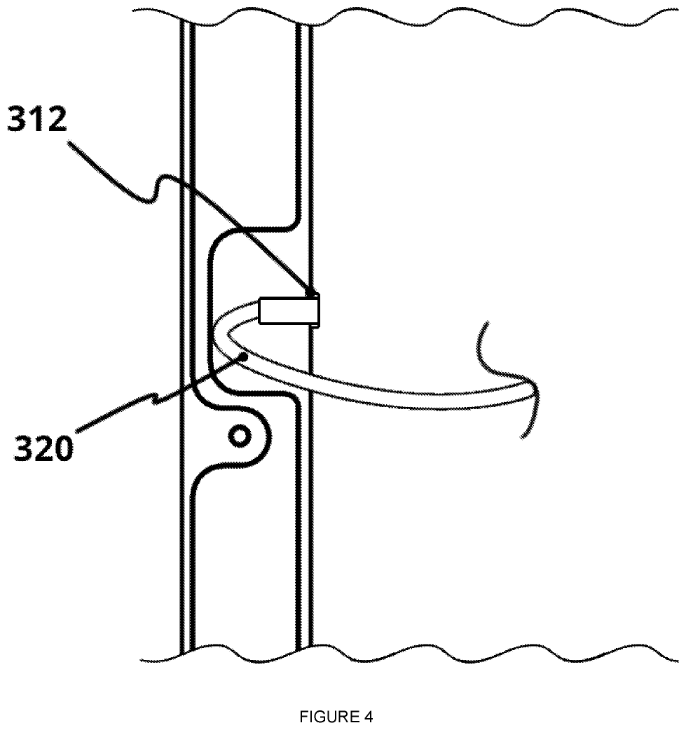

FIG. 4 is a rear cutaway view of an example front frame of an example device mount compatible enclosure in accordance with some implementations. FIG. 4 shows a slot cut-out view of FIG. 3 of the USB cable connector port (312) with the OEM connector cable (320) inserted into the port (312). The front frame is designed such that the cable (320) snugly fits into the port (312) and minimizes the front frame bezel thickness required to accommodate the cable.

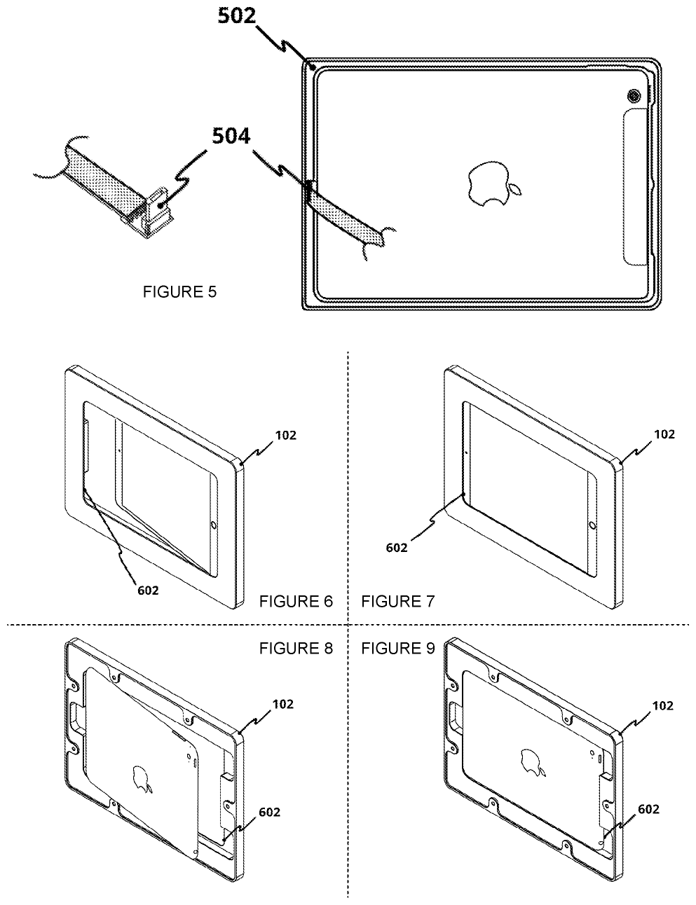

FIG. 5 is a rear view of an example front frame of an example device mount compatible enclosure along with a separate view of a specialized device connector in accordance with some implementations. FIG. 5 shows a front frame (502) that requires a specialized device connector (504) due to the size constraints and the space constraints imposed by the front frame (502). In such cases, the OEM connector cable (320) above may not properly fit into the front frame (502).

FIG. 6 is a front isometric view of an example front frame of an example device mount compatible enclosure with an example device not completely fitted in the front frame in accordance with some implementations. FIG. 7 is a front isometric view of an example front frame of an example device mount compatible enclosure with an example device completely fitted in the front frame accordance with some implementations. FIG. 8 is a rear isometric view of an example front frame of an example device mount compatible enclosure with an example device not completely fitted in the front frame in accordance with some implementations. FIG. 9 is a rear isometric view of an example front frame of an example device mount compatible enclosure with an example device completely fitted in accordance with some implementations. In these four illustrations, the front hole (602) in the front frame (102) is sized and shaped so as to render the front face of the enclosed device to be accessible through the enclosure while preventing unauthorized removal of the device through the front hole (602) of the enclosure.

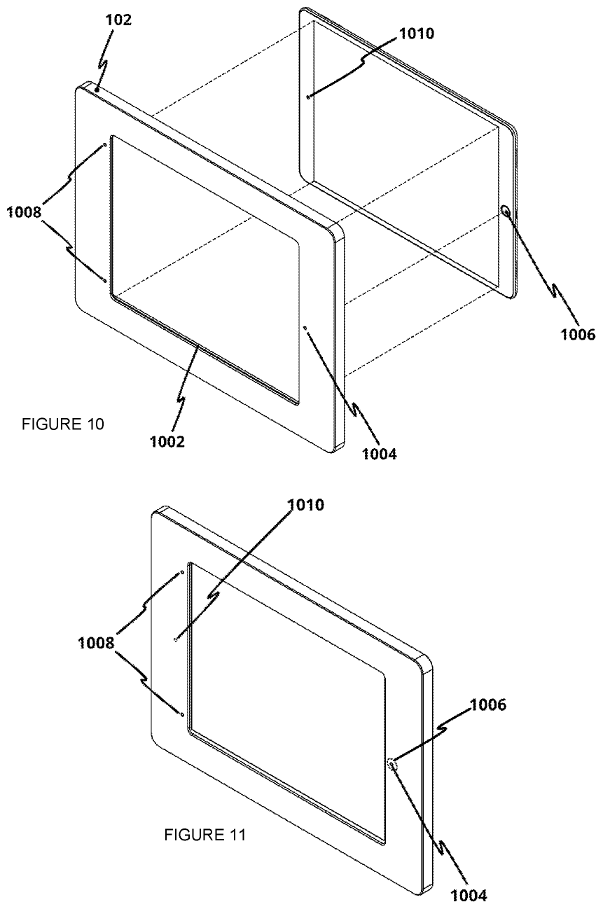

FIG. 10 is a front isometric view of an example device mount compatible enclosure with an example device not completely fitted in accordance with some implementations. FIG. 11 is a front isometric view of an example device mount compatible enclosure with an example device completely fitted in accordance with some implementations. In these illustrations, the front hole (1002) of the front frame (102) are sized and shaped to leave only the screen of the enclosed device accessible through the enclosure while preventing the device from being removed through the front hole (1002). The illustrations also show service holes (1004) that are placed at certain locations to enable limited access to the device's front button (1006) and the device's optical, light, or LIDAR sensors (1008). In these illustrations, the enclosed device's front camera (1010) and front button (1006) are covered by the frame after enclosing the device within the enclosure.

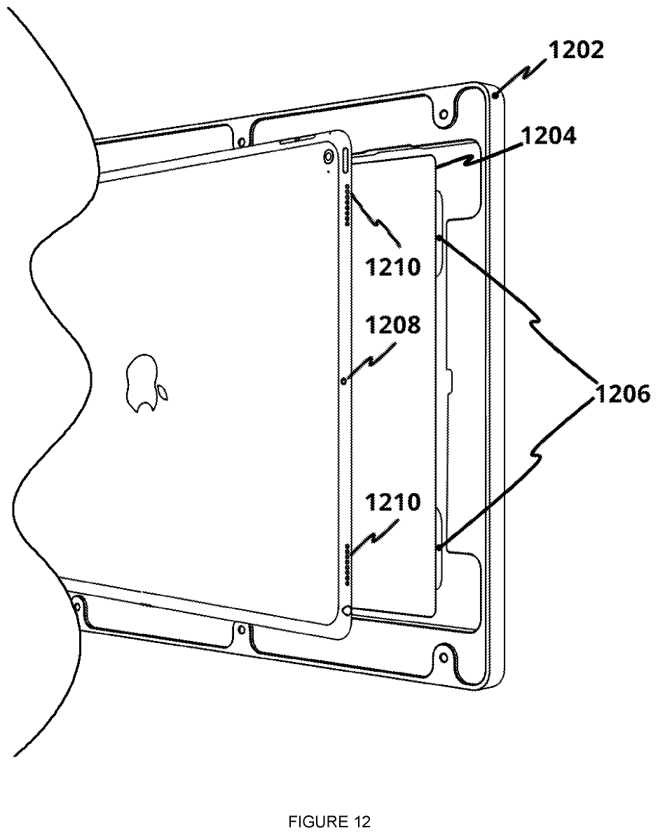

FIG. 12 is a rear isometric view of an example front frame of an example device mount compatible enclosure with an example device not completely fitted in accordance with some implementations. FIG. 12 shows an inside edge of a front hole (1204) of a front frame (1202) that includes an undercut (1206). The undercut (1206) forms an open-air path for sound waves to travel from the ambient environment into the example device's microphone(s) (1208) and/or from the speaker(s) (1210) to the ambient environment. The undercut (1206) obviates the need for locating holes/slots on the front face plate to facilitate audio input/output functionality.

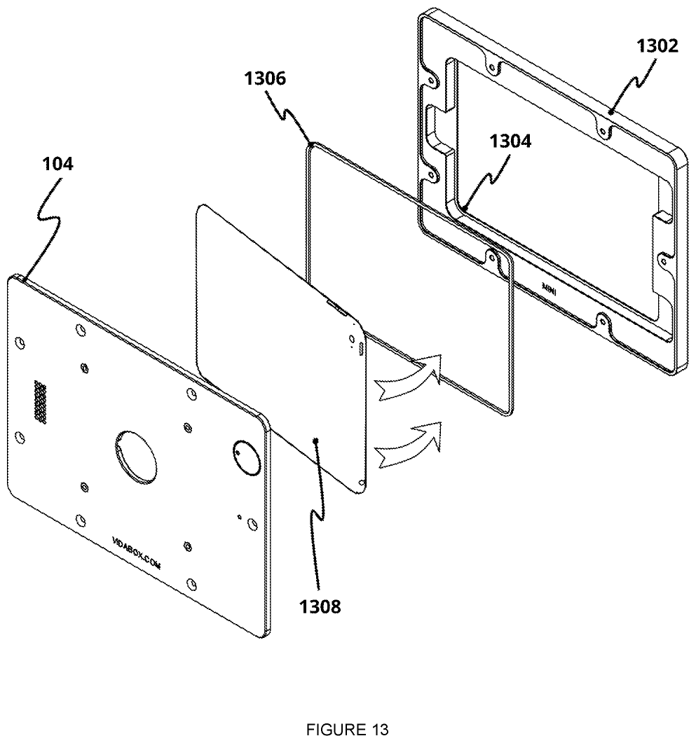

FIG. 13 is a rear isometric view of an example device mount compatible enclosure with an example device and an example gasket in accordance with some implementations. FIG. 13 shows a waterproof and/or dustproof gasket (1306) that can be placed between the Front Hole (1304) of the front frame (1302) and the example device (1308). The gasket (1306) prevents dust and/or water from entering into the disclosed enclosure through the front hole (1304).

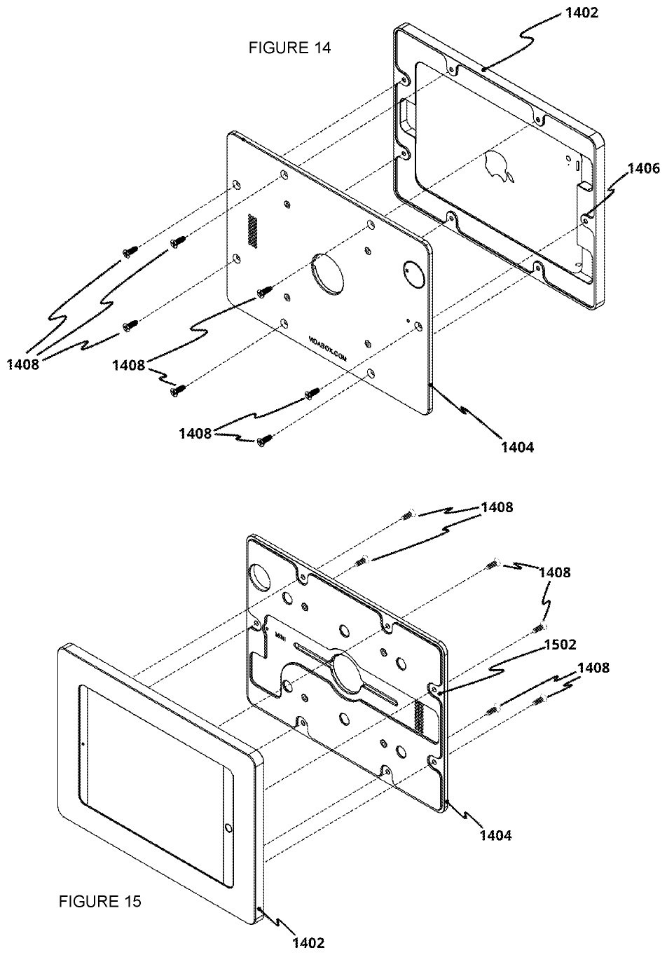

FIG. 14 is a rear isometric view of an example device mount compatible enclosure in accordance with some implementations. FIG. 15 is a front isometric view of an example device mount compatible enclosure in accordance with some implementations. FIG. 14 and FIG. 15 show a design for the mechanical assembly of a front frame (1402) and a back plate (1404) by fastening these two parts together. In FIG. 14, the front frame (1402) has a set of ridges, protrusions, and/or features (1406) that correspondingly match or align with a complementary set of ridges, protrusions, and/or features (1502) of the back plate (1404) shown in FIG. 15, thereby enabling the front frame and the back plate to align, interface, and interlock and be secured together by fasteners (1408). In some implementations, such fasteners (1408) can include screws.

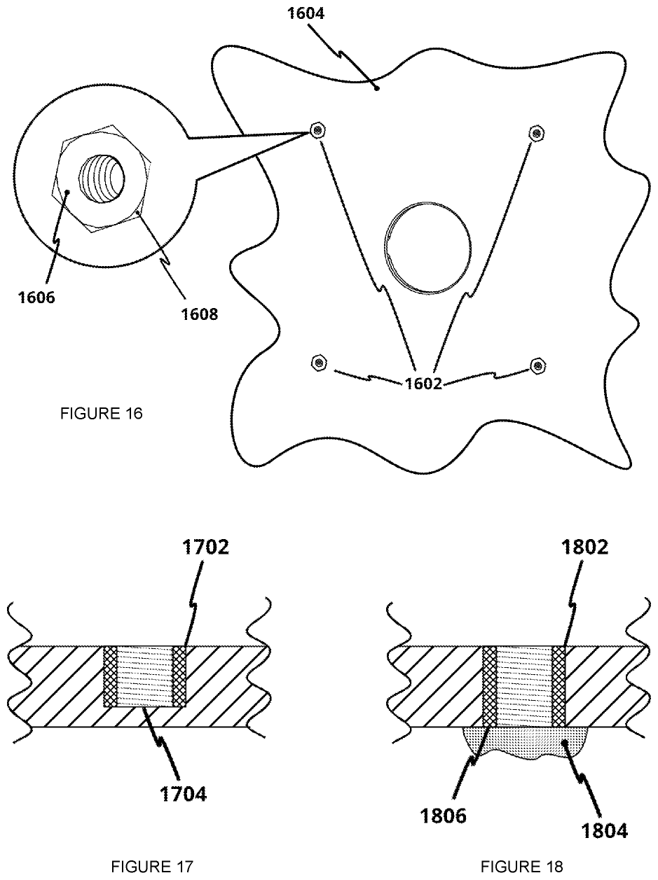

FIG. 16 is a front cutaway view of an example back plate of an example VESA mount standard compliant enclosure along with a magnified view of an example fastener used in the enclosure in accordance with some implementations. FIG. 16 shows an example VESA 100×100 mounting pattern (1602) that is designed on a back plate (1604) by embedding PEM fasteners (1606) into four through holes (1608) to form a square VESA 100×100 mounting pattern. This VESA 100×100 mounting pattern (1602), for example, enables the enclosure to be subsequently secured using any corresponding VESA 100×100 compatible mounting bracket.

FIG. 17 is a cutaway view of an example VESA mounting pattern of an example VESA mount standard compliant enclosure in accordance with some implementations. FIG. 17 shows an example PEM fastener based VESA 100×100 mounting hole (1702) that is designed as an example blind hole (1704) to prevent dust and/or water from entering the mounting hole (1702).

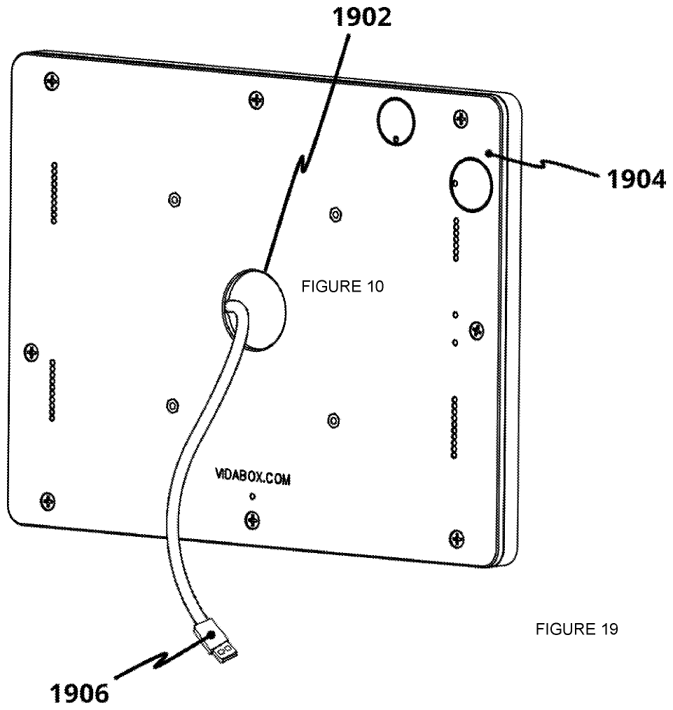

FIG. 18 is a cutaway view of an example VESA mounting pattern of an example VESA mount standard compliant enclosure in accordance with some implementations. FIG. 18 shows an example PEM fastener based VESA 100×100 mounting hole (1802) with an example barrier material (1804) applied to the fastener opening (1806) on an inside surface of a back plate to prevent dust and/or water from entering the mounting hole (1802). The barrier material may include silicone, plastic, foam, sealants, or the like, and may be applied on the mounting hole (1802) after the enclosure has been manufactured but prior to the assembly of the enclosure.

FIG. 19 is a front perspective view of an example back plate of an example device mount compatible enclosure in accordance with some implementations. FIG. 19 shows a back plate (1904) that is designed with a centered thru hole (1902) to allow connectors, wires, and/or cables (1906) to pass through the back plate from within the enclosure to outside the enclosure.

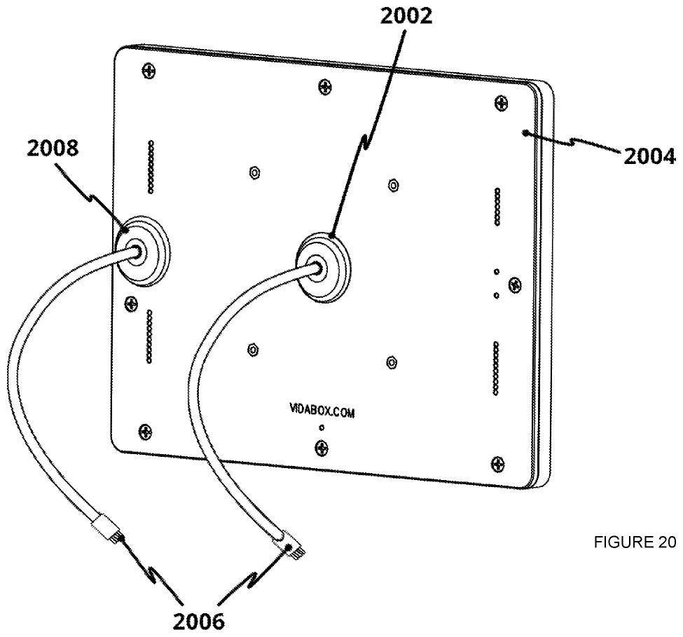

FIG. 20 is a front perspective view of an example back plate of an example device mount compatible enclosure in accordance with some implementations. FIG. 20 shows a back plate (2004) that includes a centered waterproof cable gland (2002) for providing a waterproof pathway for connectors, wires, and/or cables (2006) to pass through the back plate from within the enclosure to outside the enclosure. FIG. 20 shows another waterproof cable gland (2008) that is located at or near an I/O Port area of an example device that is enclosed within the enclosure. These waterproof cable glands enable the enclosure to maintain a pre-determined IP rating.

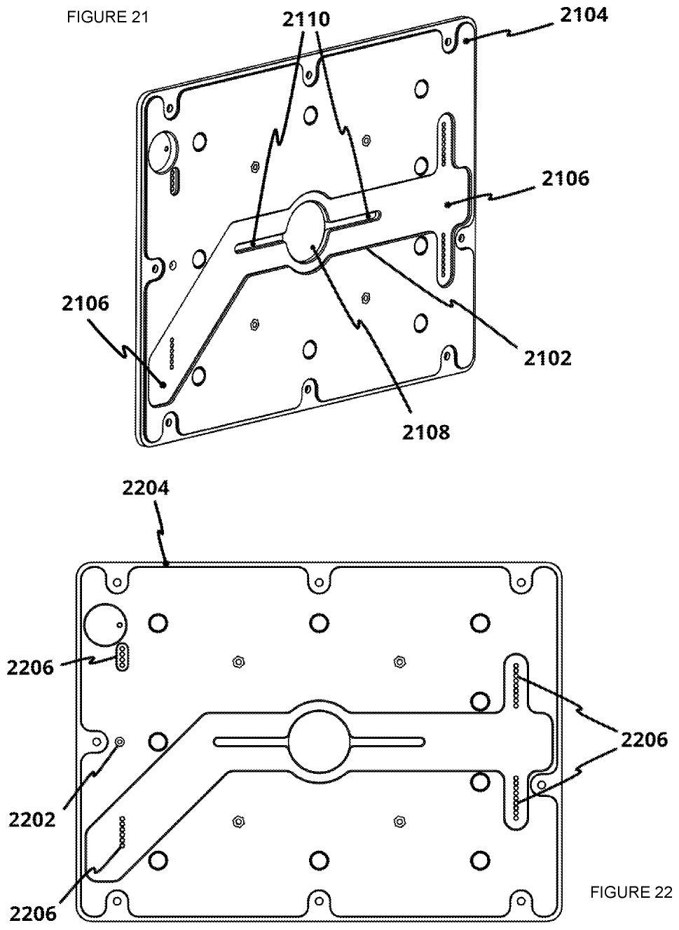

FIG. 21 is a rear isometric view of an example back plate of an example device mount compatible enclosure in accordance with some implementations. FIG. 21 shows channels (2102) that are located on the inside of the back plate (2104). Channels (2102) may begin from an example device's I/O Port area (2106) and end at the center thru hole (2108) of the back plate. pre-milled grooves (PMGs) (2110), which may be co-located within the channels (2102) can be cut deeper into the back plate to enable easy removal of the material of the back plate for selecting other exit points for connectors, wires, or cables based on user requirements.

FIG. 22 is a rear view of an example back plate of an example device mount compatible enclosure in accordance with some implementations. FIG. 22 shows different sets of microphone holes/slots (2202) and speaker holes/slots/grilles (2206) located across the back plate (2204).

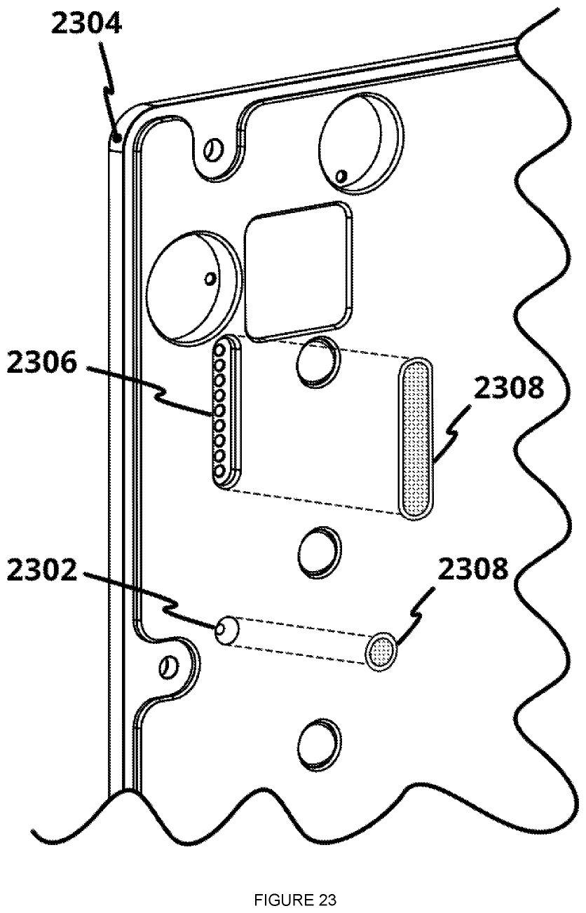

FIG. 23 is a rear cutaway view of an example back plate of an example device mount compatible enclosure in accordance with some implementations. FIG. 23 shows a set of microphone holes/slots (2302) and speaker holes/slots/grilles (2306) located on the back plate (2304). FIG. 23 also shows an acoustically transparent and waterproof material (2308), including but not limited to ePTFE fabric, covering the microphone holes/slots (2302) and the speaker holes/slots/grilles (2306) to prevent ingress of dust and/or water without affecting the audio functionality of the microphone or the speakers. The acoustically transparent and waterproof material (2308) can be installed/affixed over the microphone holes/slots (2302) or the speaker holes/slots/grilles (2306) using methods including but not limited to ultrasonic welding, chemical bonding adhesives, or by pressing waterproof material to pre-form the material as a flanged seal.

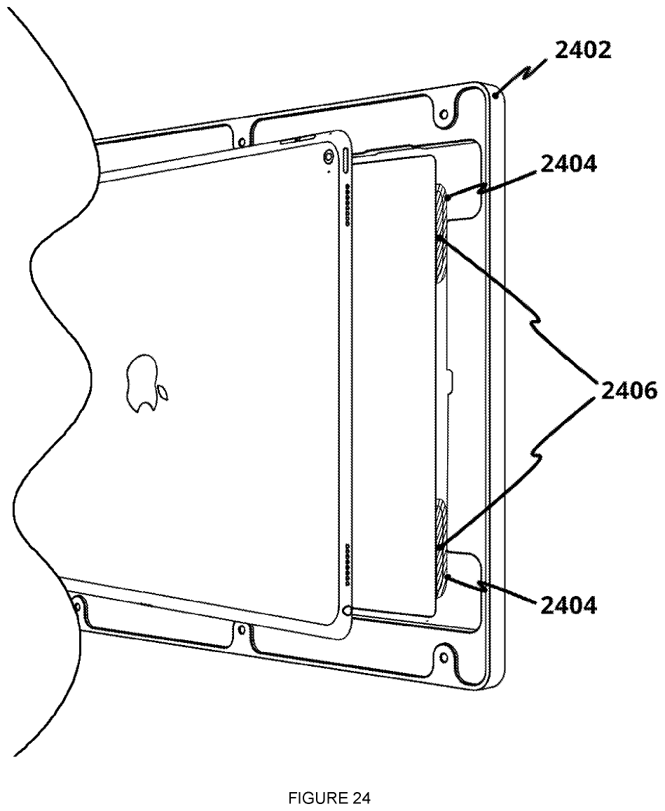

FIG. 24 is a rear cutaway view of an example front frame of an example device mount compatible enclosure in accordance with some implementations. FIG. 24 shows a set of undercuts (2404) on a rear side of a front frame (2402), with the undercuts covered with acoustically transparent and waterproof material (2406), including but not limited to ePTFE fabric, to prevent the undercuts (2404) from being a pathway for the ingress of dust and/or water into the enclosure. The acoustically transparent and waterproof material (2406) can be installed over the undercuts using methods including but not limited to ultrasonic welding, chemical bonding adhesives, and/or by pressing the material to pre-form the material as a flanged seal.

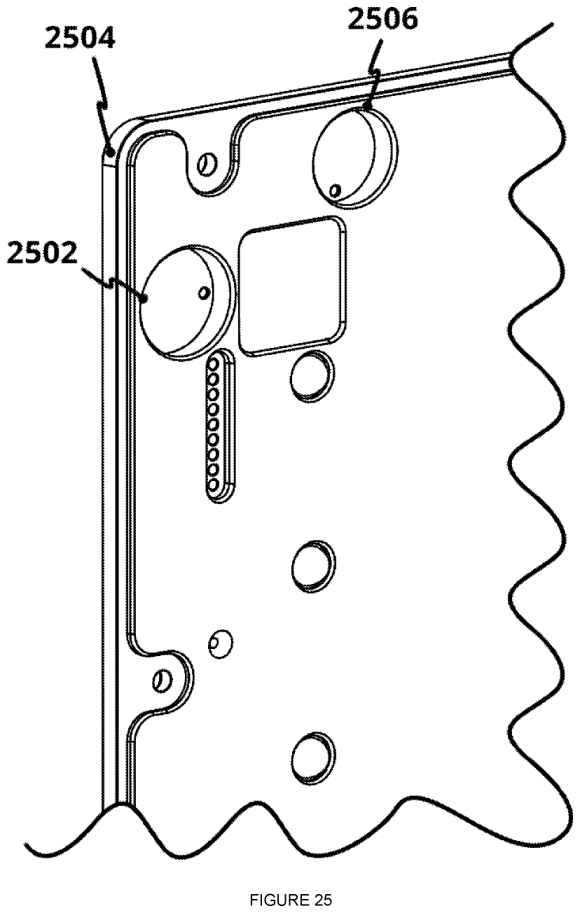

FIG. 25 is a rear cutaway view of an example back plate of an example device mount compatible enclosure in accordance with some implementations. FIG. 25 shows pre-milled knockout sections included in the back plate (2504). A first pre-milled knockout section (2502) is located at or near an area surrounding a power button of an example device and a second pre-milled knockout section (2506) is located at or near a volume button of the example device. The aforementioned pre-milled knockout sections can be removed as and when required to enable a user to access the power and volume buttons of the example device.

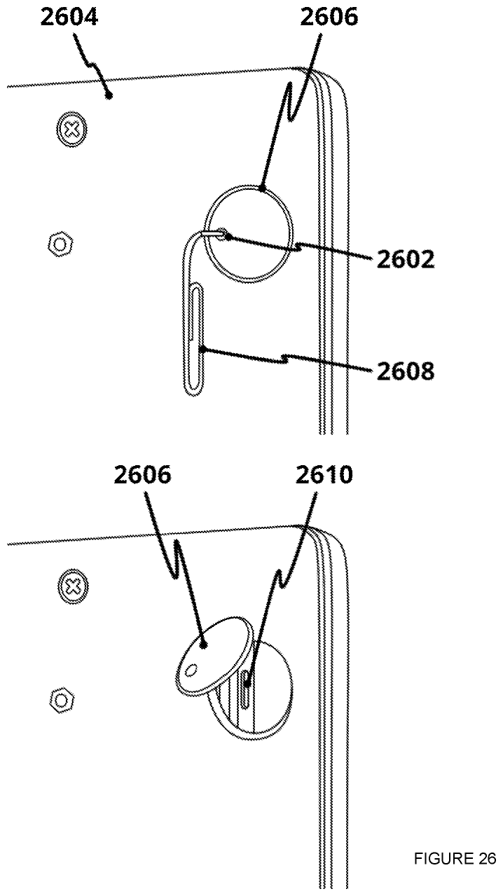

FIG. 26 shows rear cutaway views of an example back plate of an example device mount compatible enclosure in accordance with some implementations. FIG. 26 shows a back plate (2604) design that includes a service hole (2602) in a pre-milled knockout section (2606). The service hole is shaped and sized to permit a pin or a paperclip (2608) to pass through the hole. Using a pin or paperclip or other such object, a user can press and/or actuate a button(s) (2610) behind the pre-milled knockout section (2606). Alternatively, the pre-milled knockout section (2606) can be removed as and when required to enable users to access the hidden button(s).

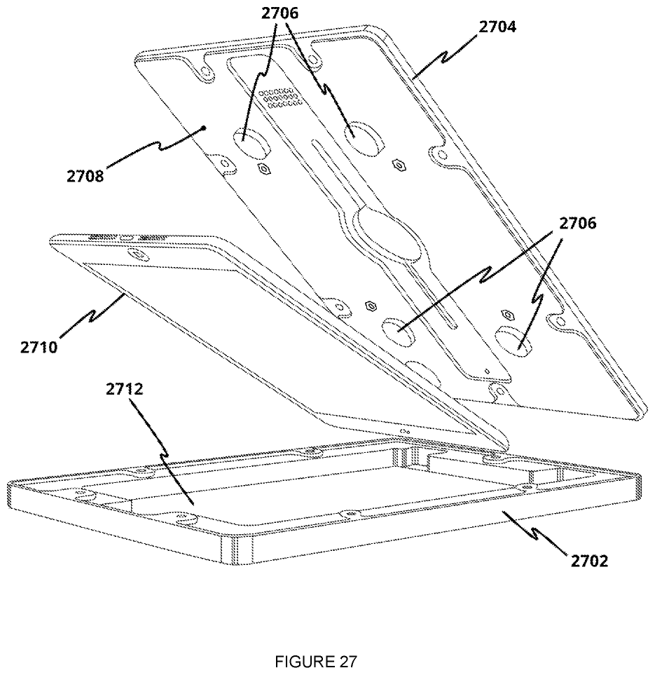

FIG. 27 shows isometric rear views of a front frame and a back plate of an example device mount compatible enclosure in accordance with some implementations. FIG. 27 shows a set of elastomeric bumpers (2706) with a consistent, fixed height and spring constant included on the inside surface (2708) of a back plate (2704). The elastomeric bumpers (2706) are designed to press against the back of an example device (2710) and towards the front hole (2712). The example device (2710) is enclosed between the front frame (2702) and the back plate (2704).

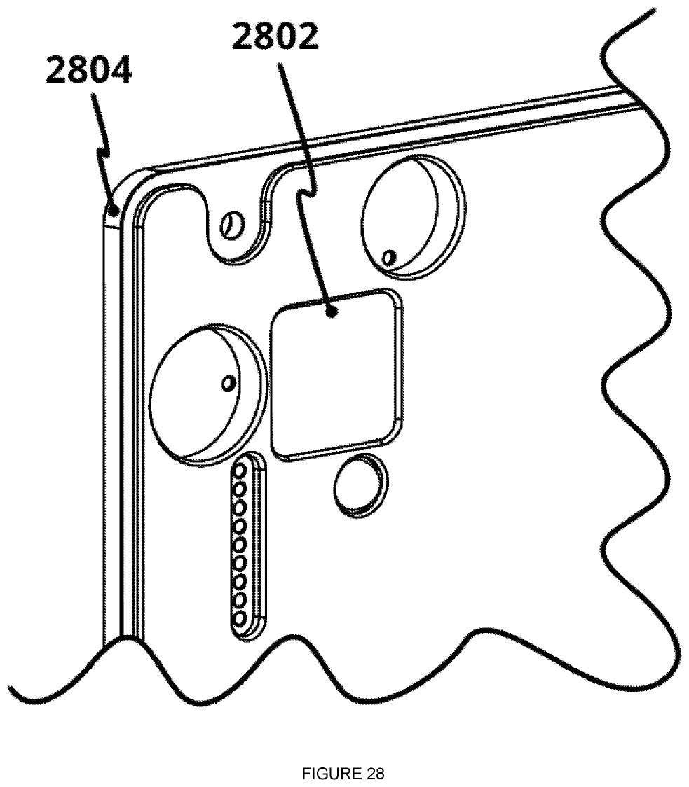

FIG. 28 is a rear cutaway view of an example back plate of an example device mount compatible enclosure in accordance with some implementations. FIG. 28 shows a slot or a hole or a channel (2802) milled into a surface of a back plate (2804) to enable profile elements or protrusions such as cameras or button(s) of an example device to not be crushed by the back plate during assembly.

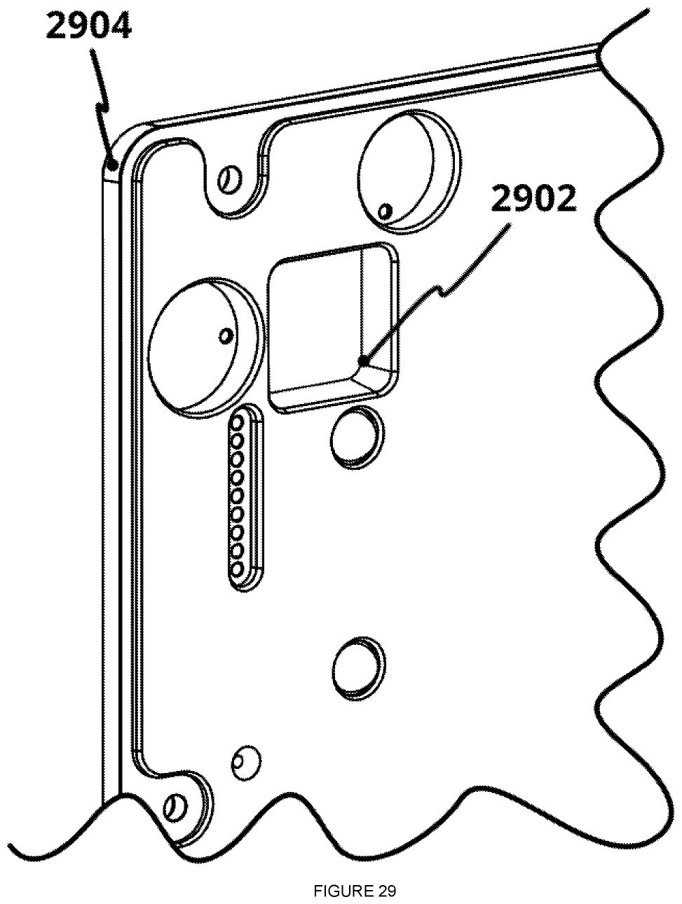

FIG. 29 is a rear cutaway view of an example back plate of an example device mount compatible enclosure in accordance with some implementations. FIG. 29 shows a thru hole (2902) instead of a milled hole to enable profile elements or protrusions such as camera(s) or button(s) of an example device to have an open air access through the back plate (2904). The arrangement in FIG. 29 gives peripherals such as cameras free, open, and unimpeded access to the environment.

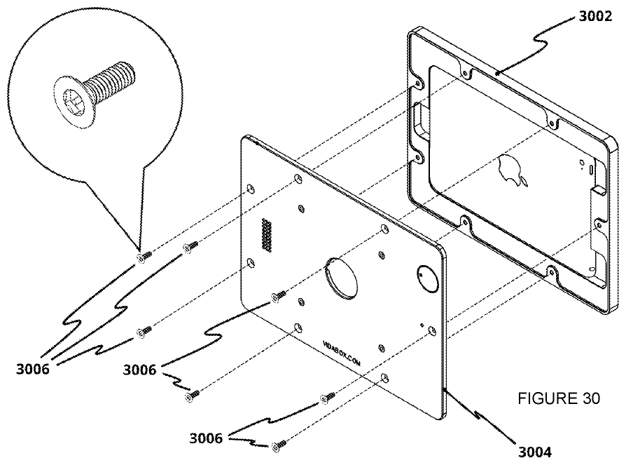

FIG. 30 is a rear isometric view of an example device mount compatible enclosure along with a magnified view of an example fastener used in the enclosure in accordance with some implementations. FIG. 30 shows a mechanical assembly of a Back Plate (3004) and a front frame (3002) using a plurality of fasteners affixed/fastened around a perimeter or a periphery of the enclosure. FIG. 30 shows a magnified view of a proprietary pin-in-hex screw (3006) but any other type of generic or proprietary fasteners can be used instead.

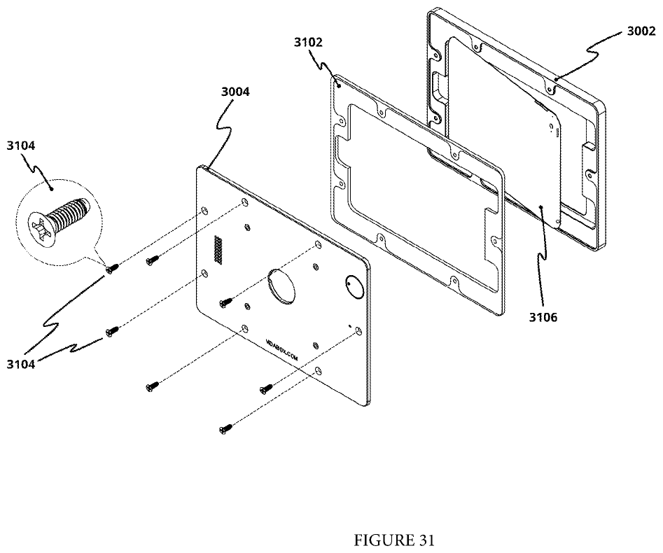

FIG. 31 is a rear isometric view of an example device mount compatible enclosure along with a magnified view of an example fastener used in the enclosure in accordance with some implementations. FIG. 31 shows a custom designed, water-tight, matching gasket (3102). FIG. 31 shows the gasket (3102) sandwiched between the front frame (3002) and the back plate (3004). The gasket (3102), when inserted between the front frame (3002) and the back plate (3004), creates a hermetic seal. FIG. 31 also shows a mechanical assembly of the back plate (3004) and the front frame (3002) using a plurality of fasteners (3104) fastened around a perimeter or a periphery of the enclosure. the fasteners (3104) fasten the front frame (3002) and the back plate (3004) together, making the hermetic seal even more effective. FIG. 31 also shows an example device (3106) that is partially enclosed within the disclosed enclosure.

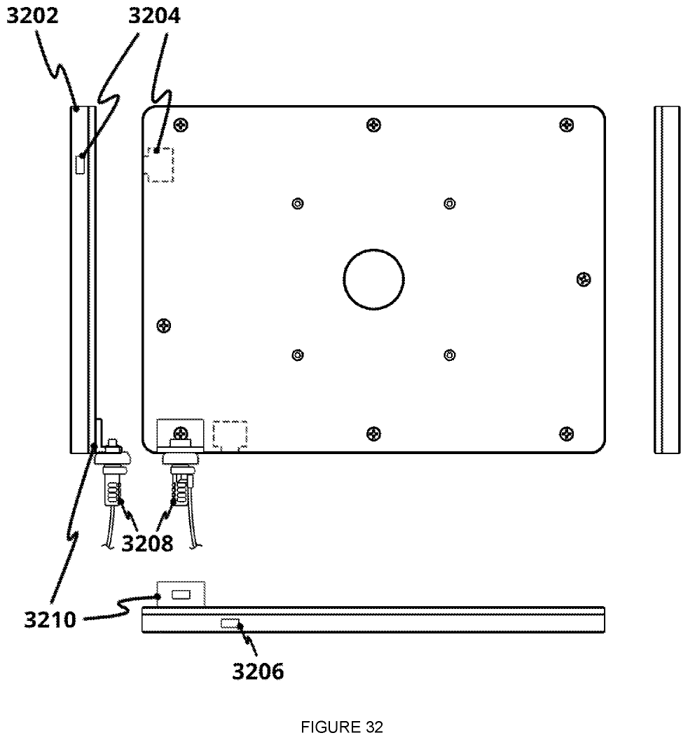

FIG. 32 shows front and top views of a Kensington Lock assembly for use with an example device mount compatible enclosure in accordance with some implementations. FIG. 32 shows a Kensington Lock (3208) and matching security lock slots (3204, 3206) designed into an edge of a bezel on a side of a front frame (3202). These security lock slots can be located anywhere along the bezel or can be included as add-ons or extensions (3210) to the enclosure.

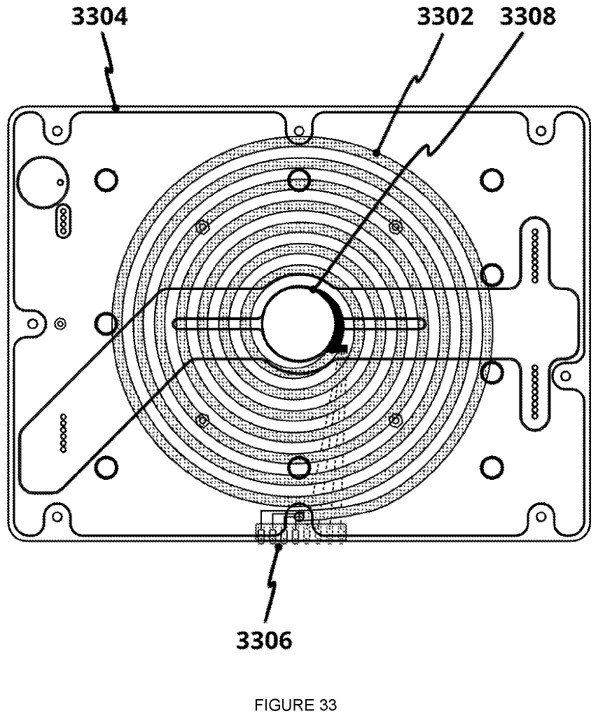

FIG. 33 is a rear view of an example back plate of an example device mount compatible enclosure in accordance with some implementations. FIG. 33 shows an inductive coil (3302) included in or embedded into a back plate (3304). The inductive coil (3302) may or may not be exposed to outside view. The back plate (3304) is designed to accommodate the inductive coil (3302). To apply voltage, current, and/or other electronic signals to the inductive coil (3302), a set of fixed contact points, pogo pins, or similar conductive elements (3306) are included in and/or embedded into an edge of the back plate and are connected to the inductive coil (3302). This design permits a removable external plug or a connector to be connected to the enclosure. Alternatively, the fixed contact points, pogo pins, or similar conductive elements can be placed at or near the centered thru hole (3308). This design ensures that the connection between the enclosure and the matching VESA ready bracket is kept hidden and rendered tamper resistant.

In other implementations, a variety of form factors, sizes, and/or variations in the features of the disclosed implementations and embodiments of an example device mount compatible enclosure are possible. In these variants of an example device mount compatible enclosure, the enclosure may achieve a desired Ingress Protection (IP) rating, may include a bezel with a desired thickness, and/or may be secured to one or more of a VESA-ready bracket or a Kensington Lock and a tether. The variants may include a variety of mounting options as well. Therefore, the implementations and the embodiments disclosed herein are some examples of potential configurations but should not be construed as limitations on potential configurations.

It is contemplated that any optional feature of the disclosed variations described herein may be set forth and claimed independently or in combination with any one or more of the features disclosed herein. Reference to a singular item includes the possibility that there is a plurality of the same items present. More specifically, as used herein and in the appended claims, the singular forms “a”, “an”, “said”, and “the” include plural referents unless specifically stated otherwise. In other words, use of the articles allow for “at least one” of the subject item in the description above as well as in the claims below. It is further noted that the claims may be drafted to exclude any optional element. As such, this statement is intended to serve as antecedent basis for use of such exclusive terminology as “solely”, “only”, and the like in connection with the recitation of claim elements or for the use of a “negative” limitation.

In the absence of exclusive terminology such as “solely” or “only”, the term “comprising” in the claims shall allow for the inclusion of any additional element, irrespective of whether a given number of elements are enumerated in the claim, or the addition of a feature can be regarded as transforming the nature of an element set forth in a claim. Except as specifically defined herein, all of the technical and scientific terms used herein are to be given as broad a commonly understood meaning as possible while maintaining the validity of the claims.

The scope of the present disclosure is not intended to be limited to the examples or embodiments provided herein and/or to the subject specification. Use of the term “invention” or “disclosure” herein is not intended to limit the scope of the claims in any manner. Rather, it should be recognized that the “invention” or “disclosure” includes all variations explicitly or implicitly described herein, including those variations that would be obvious to one of ordinary skill in the art upon reading the present specification. Further, it is not intended that any section of this specification (e.g., the Summary, Detailed Description, Abstract, Field, etc.) be accorded special significance in describing the disclosed subject matter relative to one another or to the claims. All of the references cited are incorporated by reference in their entirely. Although the foregoing subject matter has been described in detail for purposes of clarity of understanding, it is contemplated that certain modifications may be practiced within the scope of the disclosed subject matter.

What is claimed is:

1. An apparatus for enclosing an electronic device comprising:
a front frame for retaining the electronic device, wherein a bezel of the front frame includes one or more slots, wherein the one or more slots align with one or more of one or more input ports or one or more output ports of the electronic device; and
a back plate for enclosing the electronic device, wherein the back plate includes one or more device compatible mounting patterns for mounting the electronic device.

2. The apparatus of claim 1, further comprising one or more device mounting holes.

3. The apparatus of claim 2, wherein the one or more device mounting holes include one or more of one or more through holes or one or more blind holes.

4. The apparatus of claim 3, wherein the one or more blind holes are covered with one or more of silicone, plastic, sealant, or foam.

5. The apparatus of claim 1, wherein the back plate comprises a through hole, wherein the through hole forms a passageway for one or more of cables, wires, or connectors.

6. The apparatus of claim 1, wherein the back plate comprises one or more waterproof cable glands to enable passage of one or more of cables, wires, or connectors.

7. The apparatus of claim 1, wherein the back plate comprises one or more channels.

8. The apparatus of claim 7, wherein the one or more channels originate at one or more of the one or more input ports or the one or more output ports of the electronic device.

9. The apparatus of claim 7, wherein the one or more channels terminate at one or more of a through hole of the back plate or one or more cable glands of the back plate.

10. The apparatus of claim 1, wherein the one or more slots are covered with an acoustically transparent material.

11. The apparatus of claim 10, wherein the acoustically transparent material is waterproof.

12. The apparatus of claim 1, wherein the back plate comprises one or more pre-milled knockout sections.

13. The apparatus of claim 12, wherein one or more of the one or more pre-milled knockout sections comprise one or more service holes.

14. The apparatus of claim 1, wherein the back plate comprises one or more bumpers, wherein the one or more bumpers are made of one or more of an elastomeric, a rubber-like, or a spring-like material.

15. The apparatus of claim 1, further comprising a gasket for hermetically sealing the apparatus when the electronic device is enclosed between the front frame and the back plate, wherein the gasket is one or more of dust-proof or waterproof.

16. The apparatus of claim 1, wherein the front frame is affixed to the back plate using one or more of fasteners, a slide and snap fit mechanism, an adhesive, a security screw head mechanism, or ultrasonic welding.

17. The apparatus of claim 1, further comprising a locking device mounting point.

18. An apparatus for enclosing an electronic device comprising:
a front frame for retaining the electronic device;
a back plate for enclosing the electronic device; and
a locking device mounting point, wherein the locking device mounting point is one or more of affixed, embedded, fastened, or attached to one or more of the front frame or the back plate.

19. The apparatus of claim 18, further comprising one or more fixed contact points, wherein the one or more fixed contact points include one or more of one or more pogo pins or one or more spring-loaded pins.

20. A method for securing an electronic device comprising:
enclosing the electronic device between a front frame and a back plate, wherein the back plate further comprises a locking device mounting point, and wherein the back plate includes one or more device compatible mounting patterns for mounting the electronic device; and
mounting a Kensington Lock on the locking device mounting point of the back plate.
